(19) United States
(12) Patent Application Publication
(10) Pub. No.: US 2004/0012264 A1
(43) Pub. Date: Jan. 22, 2004

(54) Field device comprising an additional power supply unit

(76) Inventors: Stefan Burger, Freiburg (DE); Gerhard Huber, Wies-Stockmatt (DE)

Correspondence Address: Felix J D'Ambrosio, Jones Tullar & Cooper, Eads Station, PO Box 2266, Arlington, VA, 22202, US

(21) Appl. No.: 10/239,844

(22) PCT Filed: Feb. 9, 2001
(86) PCT No.: PCT/EP01/01438

(30) Foreign Application Priority Data
Mar. 29, 2000 (DE) 100 15 619.3

(51) Int. Cl. H02J 7/00

(52) U.S. Cl. 307/64; 340/870.01

(57) ABSTRACT

The invention relates to a programmable field device (1) comprising a sensor (2), evaluation electronics (4) and a communication device (5) with a calling unit (7). The invention is characterized in that an additional power supply unit (10), which can be connected to the calling unit (7), is provided. The additional power supply unit (10) allows energy-intensive applications to be performed more rapidly.

The invention relates to a programmable field device.

In process control and automation technology, field devices are often used in order to detect process variables, such as flow rate, fill level, pressure, temperature, etc., using suitable measured value pickups and to convert them into an analog or digital measurement signal representing the value of the process variables.

Typically, such field devices are connected, via a data transmission system, to a central process control unit, to which the measurement signals are transmitted, for instance via 2-line current loops and/or digital data buses. Serial fieldbus systems in particular, such as HART, PROFIBUS-PA, FOUNDATION FIELDBUS CAN-BUS, and so forth, with suitable transmission protocols serve as the data transmission systems.

In the central process control unit, the transmitted measurement signals are further processed and displayed as corresponding measurement results, for instance on monitors, and/or converted into control signals for process final control elements, such as magnet valves, electric motors, and so forth.

Besides their primary function, namely to generate measurement signals, modern field devices have numerous other functions that support efficient, secure control of the process to be observed. These include, among others, such functions as self-monitoring of the field device, storing measured values in memory, generating control signals for final control elements, and so forth. Because of this high functionality of field devices, process-control functions are increasingly being shifted to the field plane, and the process control systems are correspondingly organized in a decentralized way.

Moreover, these additional functions also involve starting up the field device and connecting it to the data transmission system.

These and other functions can be achieved only by means of programmable field devices, whose field device electronics include a microcomputer and software implemented accordingly in it.

Before the field device is put into operation, the software is programmed into a permanent memory, such as a PROM or a nonvolatile memory, such as a EEPROM, of the microcomputer and optionally loaded into a volatile member, such as RAM, for operating the field device.

The processes observed by means of field devices are subject to constant modification, both in terms of the structural embodiment of the systems and in terms of the chronological sequences of individual process steps. Accordingly, the field devices must be adapted to changing process conditions and further developed. This extends on the one hand to the measured value pickups, but also and above all to the implemented functions, such as triggering the measured value pickup, evaluating the measurement signals, or presenting the measurement results, as well as communications with the data transmission system.

The field devices are sometimes supplied with power (4 to 20 mA, Hart, or Profibus-PA) via 2-wire lines. The 2-wire line simultaneously serves to transmit data from the field device to the central process control unit. As a rule, 2-wire lines are limited in terms of the supply of voltage and current; this is especially true in areas at risk of explosion.

Because the power consumption of field devices that are supplied via a 2-wire line is extremely restricted, such devices are also known as low-power devices. Energy-intensive applications can therefore be performed only slowly.

Changes in the memory in particular, that is, reading relatively large amounts of data in or out, are energy-intensive and therefore very time-consuming. Such changes are necessary in the case of servicing, where a technician goes to the field device on site.

In the case of a radar level meter, the readout of a new envelope curve takes about 1 to 3 minutes. Such delays in the case of servicing are time-consuming and expensive.

The object of the invention is to create a field device that makes faster work possible during servicing.

This object is attained by a programmable field device, which has a sensor, an electronic evaluator, and a communications unit with a connection unit, in which an additional power supply unit is provided that can be connected to the connection unit.

The power supply unit advantageously has a battery.

Alternatively, the power supply unit has solar cells.

A Peltier element, a radio energy receiver, a vibrational energy converter, and a rotational energy converter are all conceivable examples of further advantageous embodiments for the power supply unit.

In a preferred feature of the invention, the power supply unit can be connected to a servicing socket disposed on the field device.

In a further preferred feature of the invention, the power supply unit is embodied as explosion-proof.

The essential concept of the invention is that by means of an additional power supply unit, enough electrical energy can be supplied to the field device so that certain applications (energy-intensive writing in a memory or interrogation of a memory) can be performed faster.

The invention is described in further detail below in terms of a preferred exemplary embodiment shown in the drawing.

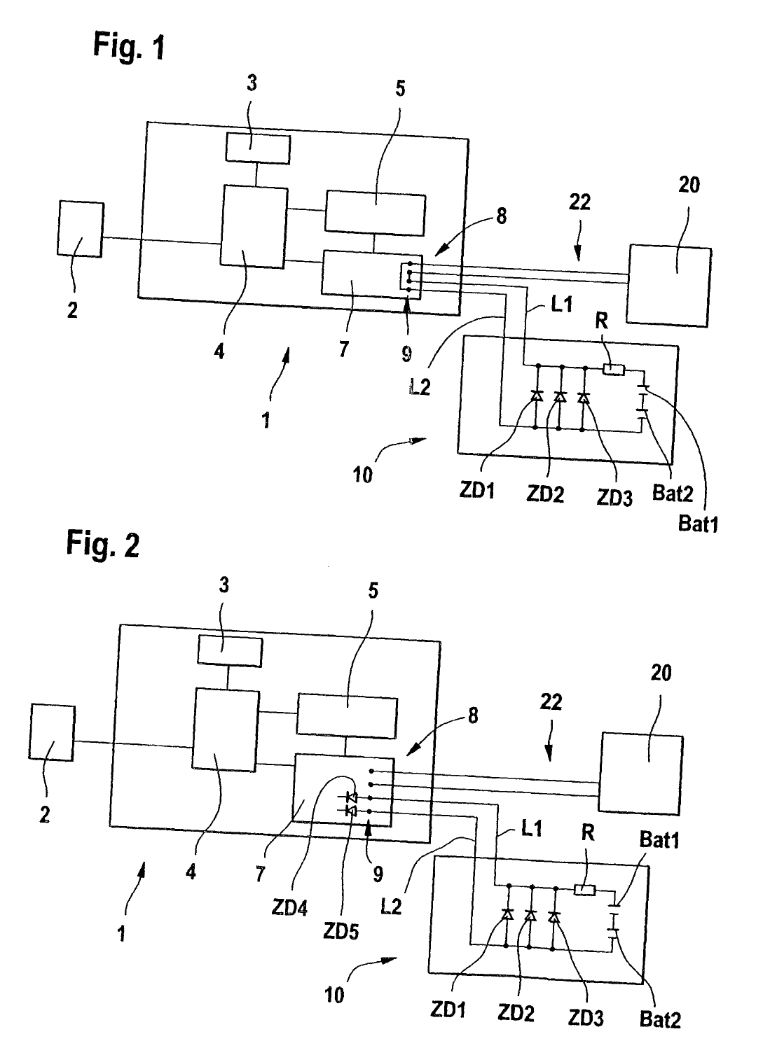

FIG. 1 is a schematic illustration of a field device with a power supply unit in a first exemplary embodiment; and

FIG. 2 is a schematic illustration of a field device with a power supply unit in a second exemplary embodiment.

FIG. 1 shows a field device 1, which is connected to a sensor 2. The field device substantially comprises an electronic unit 4, which includes a microcomputer and a memory, and a communications unit 5. The electronic unit 4 evaluates the sensor signal of the sensor 2 and outputs a measurement signal representing the measured value to the communications unit 5. The communications unit 5 transmits the measurement signal to a process control unit 20, where the measured value of the sensor 2 is evaluated and control provisions are optionally taken, which regulate the course of the process. For that purpose, the process control unit 20 triggers actuators, not shown.

The electronic unit 4 is also connected to a display unit 3, which for instance serves to display the measured value of the sensor 2.

The communications unit 5 is connected to a connection unit 7, which has a 2-wire connection 8 and a servicing socket 9. The 2-wire connection 8 is connected to a 2-wire line 22, which leads to a process control unit 20. Both the communication between the field device 1 and the process control unit 20 and the power supply of the field device 1 take place via the 2-wire line 22. A servicing socket 9 is connected parallel to the 2-wire connection 8.

A power supply unit 10 is disconnectably connected to the servicing socket 9. In the exemplary embodiment shown, the power supply unit 10 has two series-connected 12-Volt batteries Bat1 and Bat2.

In explosion-proof applications, additional diodes ZD1, ZD2 and ZD3 are provided, which are disposed between the two battery connection lines L1 and L2. The communications unit 10 comprises a plastic housing and is completely potted.

In a second exemplary embodiment, the 2-wire connection 8 and the servicing socket 9 in the connection unit 7 are connected not parallel but rather separately. Two diodes ZD4 and ZD5, in explosion-proof applications, prevent the return flow of current from the field device 1 to the power supply unit 10.

The mode of operation of the invention will now be described in further detail. In the event of servicing, the technician goes to the field device on site at a process component.

If it is necessary for data in the memory of the field device to be changed, for instance, then the power supply unit 10 is connected to the field device 1 via the servicing socket 9. The data can be transmitted for instance between the field device 1 and a handheld device, portable PC, or other communications devices, by means of a 2-wire connection.

Particularly in the event of servicing, envelope curves from the field device 1 must be read out to a portable communications device and then evaluated. Such envelope curves comprise a large quantity of data whose readout is energy-intensive.

The field device can also be parametrized from outside via the communications device. In this case as well, it may be necessary to transmit a large quantity of data.

If a rapid change in a fill level occurs when a tank is filled or emptied, then sufficiently fast data transmission is necessary for the sake of evaluation. With conventional field devices, following rapid changes is therefore impossible.

By means of the supply unit 10, enough electrical power is available to the field device for even energy-intensive applications to be performed quickly.

In particular, envelope curves can be read out of the field device 1 more rapidly.

As a result, the time expended for servicing can be shortened considerably.

Various energy sources for the power supply unit 10 are conceivable.

Besides batteries, solar cells, Peltier elements, receivers for radio energy, vibrational energy converters, and so forth are conceivable.

1. A programmable field device (1), having a sensor (2), an electronic evaluator (4), and a communications unit (5) with a connection unit (7), characterized in that an additional power supply unit (10) is provided, which can be connected to the connection unit (7).

2. The programmable field device of claim 1, characterized in that the power supply unit (10) has at least one battery Bat.

3. The programmable field device of claim 1, characterized in that the power supply unit (10) has solar cells.

4. The programmable field device of claim 1, characterized in that the power supply unit (10) has a Peltier element.

5. The programmable field device of claim 1, characterized in that the power supply unit (10) has a receiver for radio energy.

6. The programmable field device of claim 1, characterized in that the power supply unit (10) has a vibrational energy converter or a rotational energy converter.

7. The programmable field device of one of the foregoing claims, characterized in that the power supply unit (10) is connectable via a servicing socket (9) provided on the field device (1).

8. The programmable field device of one of the foregoing claims, characterized in that the power supply unit (10) is designed for explosion-proof applications.
